(19) United States
(12) Patent Application Publication
(10) Pub. No.: US 2013/0255462 A1
(43) Pub. Date: Oct. 3, 2013

(54) CUTTING TOOL

(71) Applicant: Charlie ZHANG, Oak Brook, IL (US)

(72) Inventor: Charlie ZHANG, Oak Brook, IL (US)

(73) Assignee: D-Cut Products, Inc., Downers Grove, IL (US)

(21) Appl. No.: 13/431,158

(22) Filed: Mar. 27, 2012

(51) Int. Cl. B26D 5/16; B26D 7/01

(52) U.S. Cl. 83/522.17; 83/628

(57) ABSTRACT

A hand operated cutting tool for cutting building materials, such as trim pieces, at an angle. The hand operated cutting tool includes a base, a blade holder with a blade, a handle with a cam rotatably connected to the base, and a working table for aligning the material to be cut with the blade. The hand operated cutting tool moves the blade between an open position and a closed position by rotating the handle.

### BACKGROUND OF THE INVENTION

1. Field of the Invention

This invention is directed to a cutting tool for cutting building materials, for example, molding and similar types of trim. More specifically, this invention relates to a cutting tool having a dual-pivot, cam action cutter with a working table for cutting the materials at an angle.

2. Discussion of Related Art

Many building projects require a builder to make many repeated angled cuts of materials, such as trim and molding, in order to fit the materials around edges or corners of a room, around windows and doors, and/or around other fixtures. Various tools are currently used to cut building materials, but most are bulky, heavy, require power to be operated, produce large amounts of dust during the cutting process, and/or result in uneven or splintered cuts.

Other known tools for cutting trim are basically pliers with a cutting blade. These pliers-like cutting tools are limited by the grip strength of the user and are made for cutting softer materials, such as laminate, and cannot be used to cut harder materials, such as wood. Further, many users of these pliers-like cutting tools complain that the tool hurts their hand.

Thus, there is a need for an improved cutting tool for cutting materials. Specifically, there is a need for a portable, hand-operated cutting tool that is able to cut trim at an angle in a predictable and straight fashion without splintering, cracking or similar problems.

### SUMMARY OF THE INVENTION

A general object of the invention is to provide a cutting tool for cutting narrow building materials, such as door and window trim, at an angle, generally a 45° angle.

The cutting tool of this invention includes a base having a lower portion and a riser. The base preferably has a shape that provides a solid foundation for the cutting of materials. In a preferred embodiment of this invention, the riser extends from the lower portion of the base at an angle to create a gap between a distal end of the riser and a section of the lower portion to accommodate the materials to be cut.

The cutting tool further includes a blade holder and a handle, each rotatably connected to the base. The blade holder and the handle preferrably rotate in opposite directions during the cutting motion. In a preferred embodiment, the blade holder has an anchored end that is rotatably connected to a section of the base that is in an area near where the riser and the lower portion of the base meet. The opposite end of the blade holder includes a free end, where the free end extends into the gap and is designed to move through the gap. A blade is connected to the blade holder. In one embodiment, the blade is permanently fixed to or integrated with the blade holder. In another embodiment, the blade is removably connected to the blade holder, allowing the blade to be removed for repairs, replacement and/or sharpening.

In a preferred embodiment, the handle has a cam end with a cam and an opposite grip end, where the cam end is rotatably connected to the riser at the distal end and with the cam positioned over and in contact with the free end of the blade holder. In one embodiment, the cam includes a generally circular shape with a pivot point offset from the center of the generally circular shape. Alternatively, the pivot point can be centered on the cam and the cam profile can include the appropriate profile.

In a preferred embodiment, the cutting tool includes a working table with a guide rail. The working table is preferably connected to the base at a position adjacent to the gap to support the material to be cut. The guide rail is preferably arranged at an angle to the blade, preferably at 135° to the blade to make 45° angle cuts, to the material. The working table may also include one or more degree marks for aligning the material to be cut at another angle.

In a preferred embodiment, the cutting tool further includes a spring positioned within the base and below the blade holder. The spring preferably biases the cutting tool towards an open position.

In operation, the cam starts in the open position with a small distance between the pivot point of the cam and the blade holder, as the handle is pulled downward, the gradually increasing distance between the pivot point of the cam and the blade holder forces the blade downward and through the material to be cut. The resulting cut is optimally free of splinters and a resulting cut end of the material is otherwise clean and straight.

### BRIEF DESCRIPTION OF THE DRAWINGS

These and other objects and features of this invention will be better understood from the following detailed description taken in conjunction with the drawings, wherein:

FIG. 1 is a perspective view of a cutting tool according to one embodiment of this invention in a closed position;

FIG. 2 is a perspective view of the cutting tool of FIG. 1 with a trim piece;

FIG. 3a is a side view of the cutting tool of FIG. 1;

FIG. 3b is a side view of the cutting tool of FIG. 1 with a portion of a base removed;

FIG. 4a is a side view of the cutting tool of FIG. 1 in an open position;

FIG. 4b is a side view of the cutting tool of FIG. 1 in the open position and with a portion of a base removed;

FIG. 5 is a top view of the cutting tool of FIG. 1;

FIG. 6 is a front view of the cutting tool of FIG. 1; and

FIG. 7 is a perspective view of a cutting tool according to another embodiment of this invention in a position between an open and a closed position.

### DESCRIPTION OF PREFERRED EMBODIMENTS

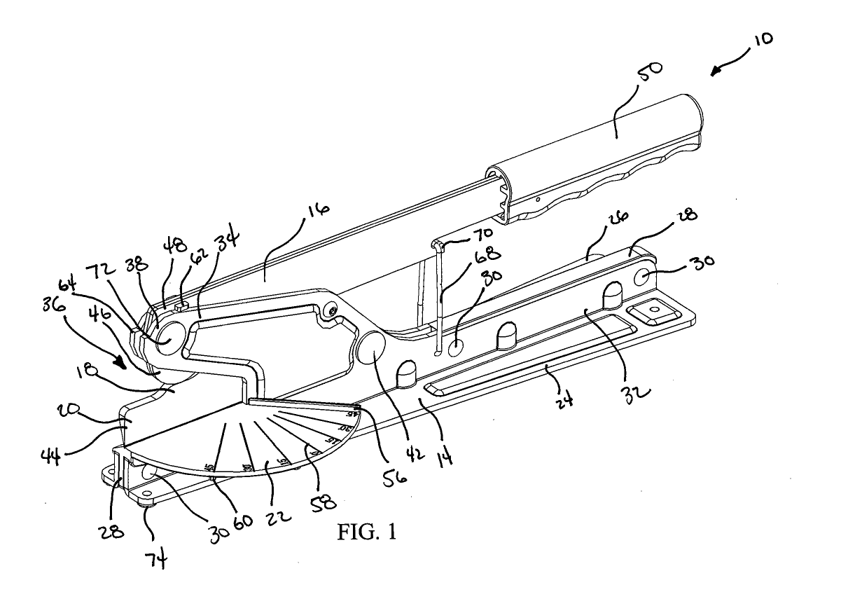

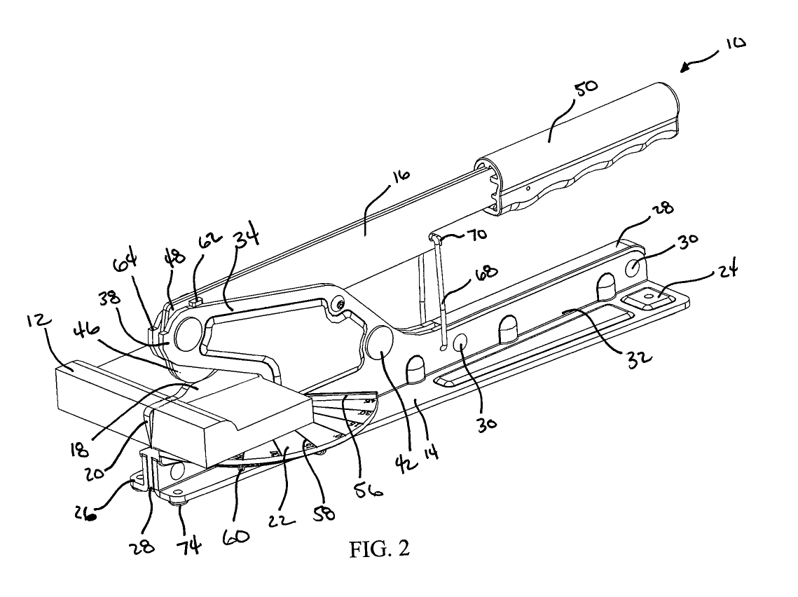

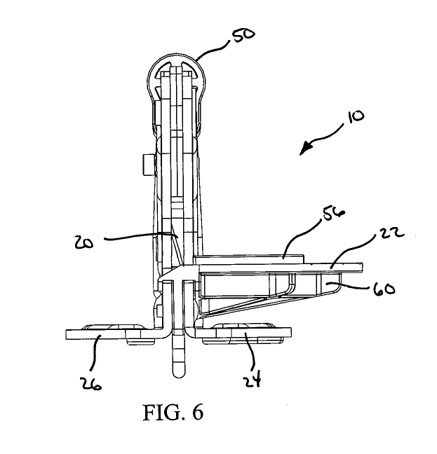

FIGS. 1-6 show a cutting tool 10 according to a preferred embodiment of this invention. The cutting tool 10 is used to cut materials 12, such as trim, at an angle, for example a 45° angle. As used herein, the materials 12 can be any type of building materials including, but not limited to, baseboards, crown molding, chair rails, window trim and door trim.

The cutting tool 10 of this invention includes a plurality of components including a base 14, a handle 16, a blade holder 18 with a blade 20 and a working table 22. Preferably, each component is manufactured from high quality materials that are able to withstand the stress applied to the cutting tool 10 as it cuts trim and other materials 12. The high quality materials may include, but are not limited to, steel, aluminum, plastics and/or composites.

According to a preferred embodiment of the cutting tool 10, the base 14 includes a first base half 24 and a second base half 26 with a spacer 28 positioned in between to provide space to accommodate the handle 16, the blade holder 18 and blade 20. Preferably, the first base half 24 and the second base half 26 are manufactured from steel and the spacer 30 is manufactured from a high-grade plastic. However, each of the first base half 24, the second blade half 26 and the spacer 28 may be manufactured from any type of material or materials that are capable of withstanding the stress of cutting through materials 12. In this embodiment, the first base half 24, the spacer 28 and the second base half 26 are joined with a plurality of fasteners 30. In an alternative embodiment, the first base half 24 and the second base half 26 can be connected to each other without a separate spacer in between. In another alternative embodiment, the base 14 can comprise a single component that incorporates elements of the first base half 24, the second blade half 26 and the spacer 28.

Each of the first base half 24 and the second base half 26 include a lower portion 32 and a riser 34. The following description will describe the first base half 24 with the understanding that the second base half 26 is largely a mirror image of the first base half 24. In this embodiment, the lower portion 32 includes an L-shaped cross-section and a triangular footprint to provide stability to the cutting tool 10. However, the lower portion is not limited to this shape and may have any shape that provides stability to the cutting tool 10. The lower portion 32 may further include a plurality of feet 74 on a bottom surface to prevent the cutting tool 10 from slipping during use and to prevent the cutting tool from damaging other surfaces.

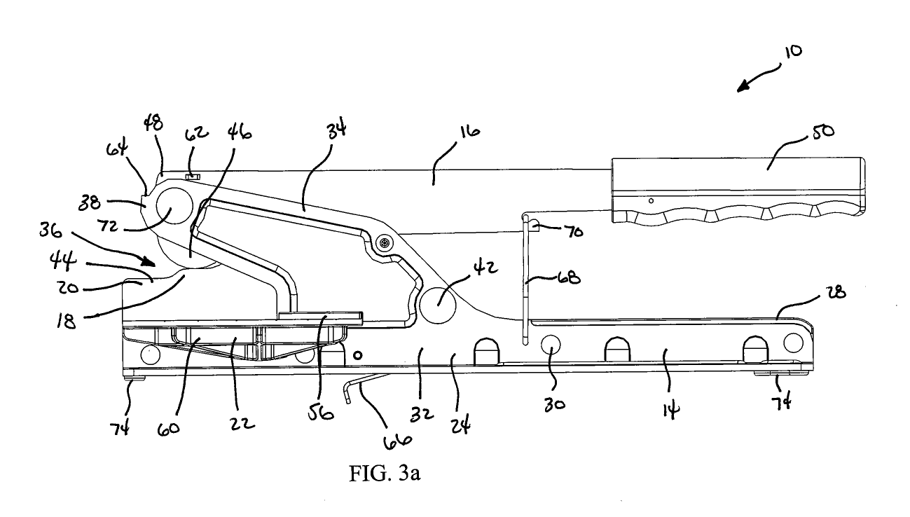

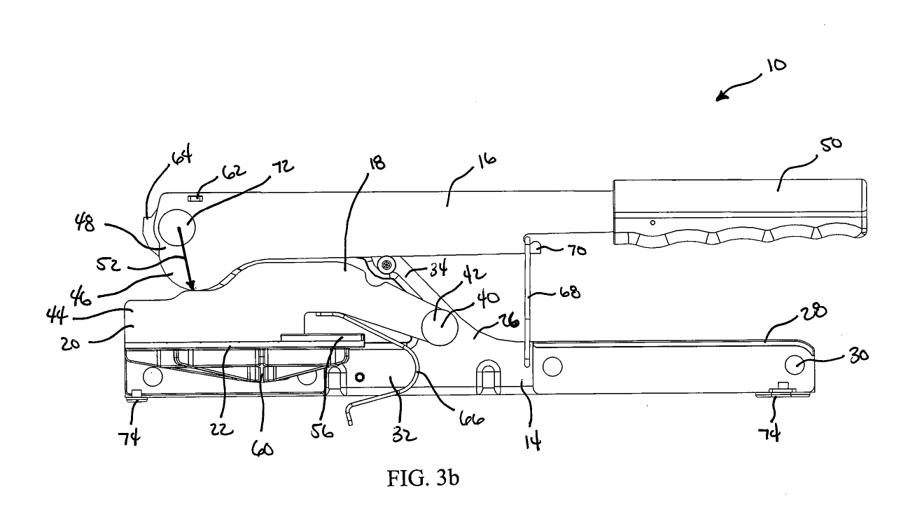

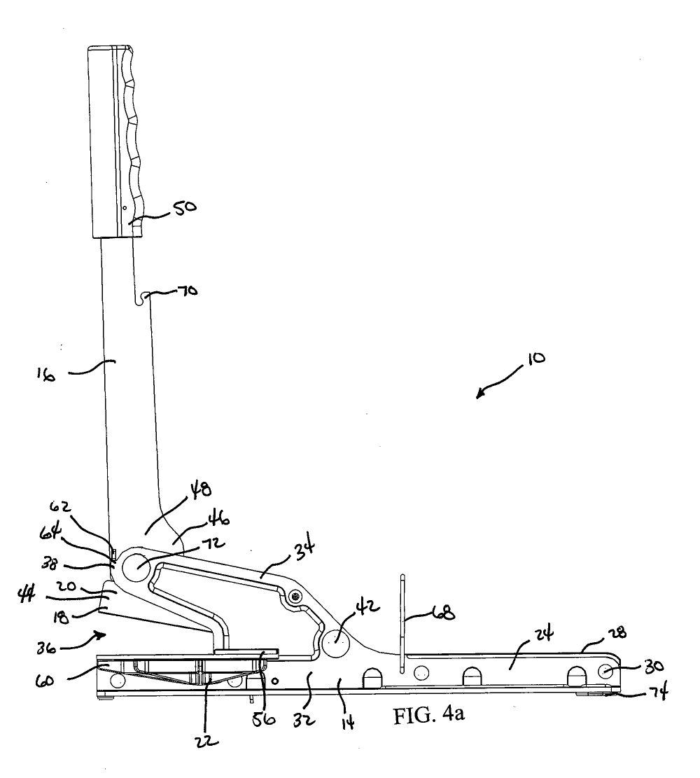

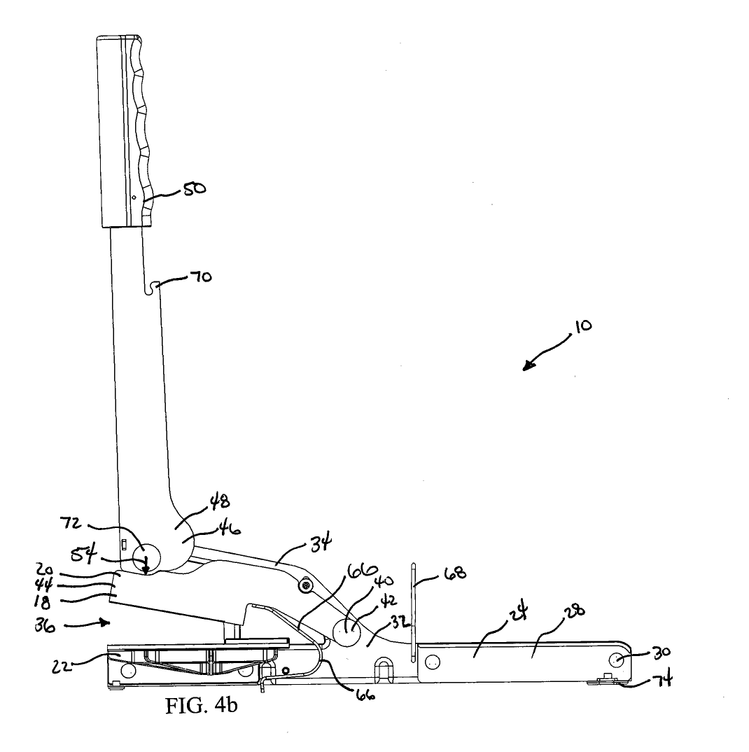

As best shown in FIGS. 3a and 4a , the riser 34 extends from the lower portion 32 at a bent-angle to form a gap 36 between a distal end 38 of the riser 34 and one end of the lower portion 32. The gap 36 provides space for the material 12 to be placed for cutting. Alternatively, the shape of the riser 36 and the size of the gap 36 may be designed to accommodate any type of material 12.

The spacer 28 is designed with a size and shape that provides room between the first base half and the second base half for other components of the cutting tool 10. In the embodiment of FIGS. 1-6, the spacer 28 includes a pair of elements, one at each end of the base 14, to provide room for other elements of the cutting tool 10 to fit in between. Alternatively, the spacer 28 may comprise any number of separate elements, including a single element that has been molded into a shape capable of accommodating the other components of the cutting tool 10.

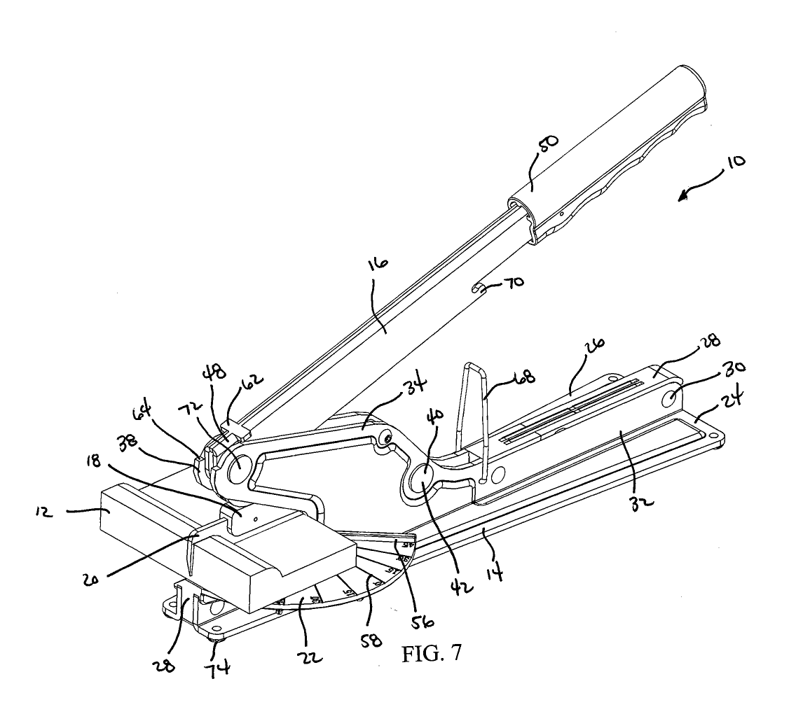

In a preferred embodiment of this invention, the blade holder 18 and blade 20 are positioned between the first base half 24 and the second base half 26. The blade holder 18 includes an anchored end 40 that is rotatably connected to the base 14 with an axle 42. Opposite the anchored end 40, the blade holder 18 includes a free end 44 that extends into the gap 36. This design allows the blade holder 18 and blade 20 to move from a closed position, as shown in FIGS. 3a-b, to an open position, as shown in FIGS. 4a-b. In the embodiment of FIGS. 1-6, the blade holder 18 and the blade 20 are integrally formed into a single element. In an alternative embodiment, as shown in FIG. 7, the blade holder 18 and blade 20 are separate elements that a connected to each other with a removable connection. This alternative embodiment, allows the blade 20 to be removed from the blade holder 18 for repair, replacement and/or sharpening.

As best shown in FIGS. 3b and 4b, the cutting tool 10 includes a spring 66 positioned under a portion of the blade holder 18 and in contact with a portion of the base 14. The spring 66 biases the cutting tool 10 upwards into the open position to allow trim 12 to be placed under the blade 20.

As shown in FIG. 1, the handle 16 is rotatably connected to the distal end 38 of the riser 34 and positioned in contact with a portion of the free end 44 of the blade holder 18. The connection between the handle 16 and the riser 34 preferably includes an axle 72. The handle 16 further includes a cam 46 at a cam end 48 of the handle 16. As best shown in FIGS. 3b and 4b, the cam 46 contacts the blade holder 18 at a large radius 52 in the closed position, FIG. 3b, and contacts the blade holder 18 at a small radius 54 in the open position, FIG. 4b. As used herein, “radius” refers to a distance from a center of rotation of the cam 46 to an edge of the cam 46.

In a preferred embodiment of this invention, the handle 16 also includes a grip 50 positioned on an end of the handle 16 opposite to the cam end 48 to assist a user when moving the handle 16 from the open position to the closed position. In a preferred embodiment, the grip 50 is a rubberized grip that includes a shape that corresponds to the shape of a hand. Alternatively, the grip 50 may be manufactured of any type of material that lessens the chances of the user's hand slipping off the handle 16. In another alternative embodiment, the grip 50 may be integrally formed with the handle 16.

The cutting tool 10 of this invention may also include a handle stop 62 on the handle 16 and a handle stop notch 64 formed in the distal end 38 of the riser 34 to prevent the handle 16 from over-rotating. The handle stop 62 extends perpendicularly from at least one surface of the handle 16. As the cutting tool moves from the closed position to the open position, the handle stop 62 runs along a portion of the riser 34 until the handle stop 62 contacts the handle stop notch 64 preventing the handle 16 from rotating further.

The cutting tool 10 of this invention also includes the working table 22 positioned next to at least one side of the base 14 and adjacent to the gap 36. The working table 22 is preferably made of a high quality plastic, such as the high quality plastic that forms the spacer 28. Alternatively, the working table may be manufactured of any high quality material including, but not limited to, steel, aluminum and a composite material. In the embodiment of FIGS. 1-6, the working table 22 is integrally formed with the spacer 28 to simplify the manufacture and assembly of the cutting tool 10. Alternatively, the working table 22 can be a separate component that is connected to the base 14.

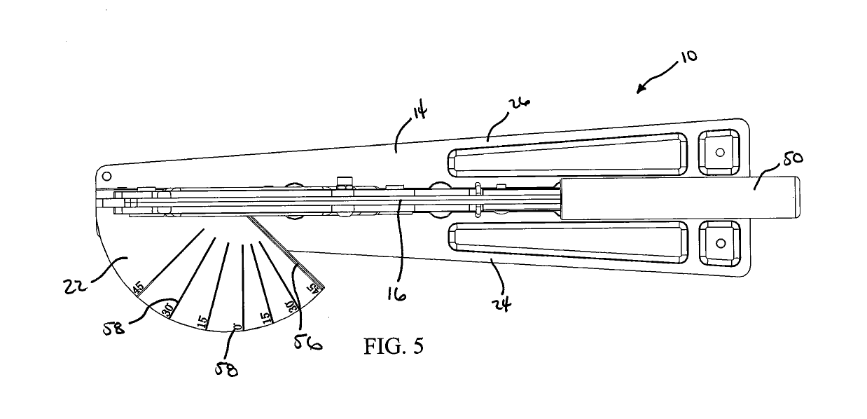

As best shown in FIG. 5, the working table 22 has a generally round shape with a guide rail 56 along at least one edge of the working table 22 for aligning the material 12 to be cut. In this embodiment, the guide rail 56 is positioned at a 135° angle to the blade 20 to cut the material at a 45° angle. Alternatively, the working table 22 may have any shape and the guide rail 56 may be set at any angle to the blade to accommodate any type of material and to provide a desired cut. In a preferred embodiment, the working table 22 further includes a plurality of degree marks 58 in a surface of the working table 22. The degree marks 58 allow a user to cut a piece of material at an angle different from the angle provided by the guide rail 56. In the embodiment of FIG. 5, the degree marks 58 are provided at 15° increments, however, the degree marks 58 may be provided at any increment of degrees.

As shown in FIGS. 3a-4b and 6, the working table 22 further includes a plurality of ribs 60 to improve the rigidity and durability of the working table 22 in a lightweight manner. In a preferred embodiment, the ribs 60 include a plurality of straight ribs and at least one round rib that intersects with the plurality of straight ribs. Alternatively, the plurality of ribs 60 may have any shape and arrangement to provide a rigid and durable surface.

In a preferred embodiment, the cutting tool 10 includes a latch 68 connected to the base 14 and a catch 70 formed in the handle 16 that can be used to maintain the cutting tool 10 in the closed position when not in use. In addition to improving the portability of the cutting tool 10, the latch 68 and catch 70 maintain the blade 20 in proximity to the to the base 14 lessening the exposure of the blade 20 thereby minimizing possible damage to the blade 20 and injury that could be caused by an exposed blade 20.

In operation, the cutting tool 10 of this invention starts in the closed position, as shown in FIGS. 1-3b. The handle 16 is pressed down slightly to allow the latch 68 to be disconnected from the catch 70. After unlocking, the handle 16 is rotated upwards, with assistance from the spring 66, into the open position, shown in FIGS. 4a-b. In the open position, the spring 66 biases the blade holder 18 upward providing an opening between the blade 20 and a portion of the base 14 for the user to insert the material 12 to be cut. The user aligns the trim 12 with one of the guide rail 56 or the degree marks 58. To cut the material, the handle 16 is lowered to rotate the cam 46. By rotating the cam 46, a gradually increasing radius of the cam 46 contacts the blade holder 18 thereby forcing the blade holder 18 and blade 20 downward as the radius increases until the cutting tool 10 is in the closed position, cutting the material 12. The resulting cut is optimally free of splinters and a resulting cut end of the material is otherwise clean and straight.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A cutting tool comprising:
a base including a lower portion and a riser, the riser extending from the lower portion to form a gap between a distal end of the riser and the lower portion;
a blade holder including a free end and an opposite anchored end, the anchored end rotatably connected to the base;
a blade connected to the blade holder and positioned within the gap;
a handle including a cam end with a cam and an opposite grip end, the cam end rotatably connected to the riser at the distal end with the cam in contact with the blade holder, the handle movable from an open position to a closed position;
wherein in the open position a small radius of the cam contacts the blade holder and in the closed position a larger radius of the cam contacts the blade holder.

2. The cutting tool of claim 1, further comprising:
a working table with a rail to support a material to be cut, wherein the rail is arranged at an angle to the blade.

3. The cutting tool of claim 2 wherein the working table includes a plurality of degree markers for lining up the material to be cut.

4. The cutting tool of claim 1, further comprising:
a spring positioned below the blade holder, wherein the spring biases the blade holder towards the open position.

5. The cutting tool of claim 1, further comprising:
a handle stop on the cam end of the handle;
a handle stop notch on the distal end of the riser; and
wherein the handle stop contacts the handle stop notch in the open position to prevent over-rotating the handle.

6. A cutting tool comprising:
a base including a lower portion and a riser, the riser extending from the lower portion to form a gap between a distal end of the riser and the lower portion;
a working table connected to the base and positioned adjacent to the gap;
a blade holder including a free end and an opposite anchored end, the anchored end rotatably connected to the base with an axle;
a blade connected to the blade holder and positioned within the gap;
a handle including a cam end with a cam, the cam end rotatably connected to the riser with a handle axle and the cam in contact with the blade holder, the handle movable from an open position to a closed position;
wherein the cam includes an cam profile that gradually increases in distance from a center of the handle axle to an edge of the cam from a narrow distance to a wide distance.

7. The cutting tool of claim 6 wherein the working table includes a guide rail at an angle to the blade for lining up a material to be cut.

8. The cutting tool of claim 7 wherein the working table includes a plurality of degree markers for lining up the material to be cut.

9. The cutting tool of claim 6, further comprising:
a spring positioned below the blade holder, wherein the spring biases the blade holder towards the open position.

10. The cutting tool of claim 6, further comprising:
a handle stop on the cam end of the handle;
a handle stop notch on the distal end of the riser; and
wherein the handle stop contacts the handle stop notch in the open position to prevent over-rotating the handle.

11. A cutting tool comprising:
a base comprising a first base half, a second blade half and a spacer positioned between the first base half and the second blade half, wherein the first base half and the second base half each comprise a lower portion and a riser, the riser extending from the lower portion to form a gap between a distal end of the riser and the lower portion;
a working table connected to the base and positioned adjacent to the gap;
a blade holder including a free end and an opposite anchored end, the blade holder positioned between the first base half and the second blade half with the anchored end rotatably connected to at least one of the first base half and the second base half;
a blade connected to the blade holder;
a handle including a cam end with a cam and an opposite grip end, the cam end positioned between the first base half and the second base half and rotatably connected to at least one of the risers and the cam is in contact with the blade holder;
wherein the handle pivots from an open position to a closed position, in the open position a small radius of the cam contacts the blade holder and in the closed position a larger radius of the cam contacts the blade holder.

12. The cutting tool of claim 11, wherein the working table includes a rail to support a material to be cut, wherein the rail is arranged at an angle of 135° to the blade.

13. The cutting tool of claim 12, wherein the working table includes a plurality of degree markers for lining up the material to be cut.

14. The cutting tool of claim 11, wherein a portion of the working table extends between the first base half and the second base half.

15. The cutting tool of claim 11, further comprising:
a spring positioned between the first base half and the second base half and positioned below the blade holder, wherein the spring biases the blade holder towards the open position.

16. The cutting tool of claim 11, wherein each of the first base half and the second base half include an L-shaped profile.

17. The cutting tool of claim 16, wherein the first base half and the second base half have a triangular-shaped footprint.
